(19) United States
(12) Patent Application Publication
(10) Pub. No.: US 2011/0041870 A1
(43) Pub. Date: Feb. 24, 2011

(54) DENTAL FLOSSER

(76) Inventors: Russell Kalbfeld, Naperville, IL (US); Jason Gross, Chicago, IL (US); Richard Demke, Homer Glen, IL (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 12/763,058

(22) Filed: Apr. 19, 2010

Related U.S. Application Data
(60) Provisional application No. 61/235,050, filed on Aug. 19, 2009.

(51) Int. Cl. A61C 15/04

(52) U.S. Cl. 132/325

(57) ABSTRACT

A dental flosser includes a housing having a pair of arms spaced apart to define a gap therebetween, a supply core rotatably coupled to the body, a wind-up spool rotatably coupled to the body for rotation in a single direction with respect to the body, a pawl movable between an engaged position that restricts rotation of the supply core with respect to the body assembly, and a disengaged position that allows the supply core to rotate with respect to the body. The flosser also includes an actuator operatively coupled to the pawl and the take-up spool. The actuator is operable to move the pawl from the engaged position to the disengaged position and to rotate the take-up spool in the first direction.

### CROSS-REFERENCE TO RELATED APPLICATION

This application claims the benefit of and priority to U.S. Provisional Patent Application No. 61/235,050 filed Aug. 19, 2009, the entire contents of which are hereby incorporated by reference.

### FIELD OF THE INVENTION

The present invention relates to dental flossers.

### BACKGROUND

Flossing is one of the most effective methods for cleaning between teeth to remove plaque buildup, a major cause of gingivitis, periodontitis, and tooth decay. The most commonly used method of flossing is to strip a large piece of floss off a dispenser, about one and one half to two feet long, wrap it around one's fingers, and to then work an exposed piece of floss between the fingers of both hands up and down against the tooth surfaces defining the interdental spaces between the teeth. Ideally, a freshly-exposed piece of floss is used for each interdental space. Otherwise, continued use of the same exposed piece will likely result in transference of plaque and bacteria from one interdental space to another, and will gradually wear away at the exposed piece of floss until its cleaning effectiveness is diminished.

For optimal results, the foregoing flossing procedure should be performed daily. However, only the most conscientious individuals adhere to such a strict schedule. This is because flossing is often regarded as an unpleasant experience, as there are a number of challenges presented by manual flossing that frequently result in a failure to floss daily. One such challenge, for example, is that it can be difficult and painful for the individual to wrap the floss tightly enough around the fingers to maintain suitable tension on the floss, and then to unwrap and rewrap the used piece to expose a fresh piece to floss the next interdental space. It is also unpleasant to handle the wet, odorous, used floss and to wrap such a material about the fingers of the hands. Additionally, gagging may occur during flossing and it can be painful to hold one's mouth open long enough and wide enough to floss every tooth, particularly the molars located near the back of the mouth. Furthermore, it is often difficult to manipulate fingers from both hands into the mouth, and in some circumstances the force required to get the floss between the teeth can be significant. Often, the floss snaps into the gum causing it to bleed. Furthermore, although floss is relatively inexpensive, significant amounts of floss frequently are used for a single cleaning, and there is considerable waste associated with the end portions of the floss that are not used for cleaning but merely for securing the floss to the user's fingers.

### SUMMARY

In some embodiments a dental flosser includes a body having a pair of arms spaced apart to define a gap therebetween, a supply core rotatably coupled to the body, a wind-up spool rotatably coupled to the body, and a pawl movable between an engaged position that restricts rotation of the supply core with respect to the body assembly, and a disengaged position that allows the supply core to rotate with respect to the body. The flosser also includes an actuator operatively coupled to the pawl and the wind-up spool. The actuator is operable to move the pawl from the engaged position to the disengaged position and to rotate the wind-up spool in the first direction.

In other embodiments a dental flosser includes a body having a pair of arms spaced apart to define a gap therebetween, a wind-up spool rotatably coupled to the body for rotation only in a first direction with respect to the body, a supply core rotatably coupled to the body, a pawl engagable with the supply core to limit the rotation of the supply core with respect to the body, and a length of floss having a first portion wound about the wind-up spool assembly, a second portion wound about the supply core, and a third portion extending between the supply core and the wind-up spool and spanning the gap. The flosser also includes an actuator operatively coupled to the pawl and the wind-up spool. The actuator is operable to move the pawl from the engaged position to the disengaged position and to rotate the wind-up spool in the first direction.

In still other embodiments a dental flosser includes a body having a pair of arms spaced apart to define a gap therebetween, and an insert positionable within the body. The insert includes a chassis having a first mounting aperture, a second mounting aperture, and a mounting pin. A wind-up spool is rotatably coupled to the first mounting aperture of the chassis for rotation in a single direction with respect to the chassis. A supply core is rotatably coupled to the second mounting aperture of the chassis, and a pawl is rotatably coupled to the mounting pin. The pawl is rotatable between an engaged position that restricts rotation of the supply core with respect to the chassis, and a disengaged position that allows the supply core to rotate with respect to the body. The chassis also includes an actuator rotatably coupled to the wind-up spool and operatively coupled to the pawl. The dental flosser also includes length of floss having a first portion wound about the wind-up spool, a second portion wound about the supply core, and a third portion extending between the supply core and the wind-up spool and spanning the gap.

Other aspects of the invention will become apparent by consideration of the detailed description and accompanying drawings.

### BRIEF DESCRIPTION OF THE DRAWINGS

FIG. 1 is a perspective view of a dental flosser embodying the invention.

FIG. 2 is an exploded perspective view of the dental flosser shown in FIG. 1.

FIG. 3a is a top perspective view of an upper housing portion of the dental flosser shown in FIG. 1.

FIG. 3b is a bottom perspective view of the upper housing portion shown in FIG. 3a.

FIG. 3c is a top view of the upper housing portion shown in FIG. 3a.

FIG. 3d is a right side view of the upper housing portion shown in FIG. 3a.

FIG. 3e is a bottom view of the upper housing portion shown in FIG. 3a.

FIG. 3f is a left side view of the upper housing portion shown in FIG. 3a.

FIG. 3g is a front view of the upper housing portion shown in FIG. 3a.

FIG. 4a is a bottom perspective view of a lower housing portion of the dental flosser shown in FIG. 1.

FIG. 4b is a top perspective view of the lower housing portion of FIG. 4a.

FIG. 4c is a left side view of the lower housing portion of FIG. 4a.

FIG. 4d is a top view of the lower housing portion of FIG. 4a.

FIG. 4e is a right side view of the lower housing portion of FIG. 4a.

FIG. 4f is a front view of the lower housing portion of FIG. 4a.

FIG. 5a is a right side perspective view of a chassis of the dental flosser shown in FIG. 1.

FIG. 5b is a left side perspective view of the chassis of FIG. 5a.

FIG. 5c is a right side view of the chassis of FIG. 5a.

FIG. 5d is a front view of the chassis of FIG. 5a.

FIG. 5e is a left side view of the chassis of FIG. 5a.

FIG. 5f is a rear view of the chassis of FIG. 5a.

FIG. 5g is a top view of the chassis of FIG. 5a.

FIG. 6a is a perspective view of a core of the dental flosser shown in FIG. 1, the core supporting a supply of dental floss.

FIG. 6b is a side view of the core of FIG. 6a.

FIG. 6c is an end view of the core of FIG. 6a.

FIG. 7a is a perspective view of a gear member of the dental flosser shown in FIG. 1.

FIG. 7b is an alternate perspective view of the gear member of FIG. 7a.

FIG. 7c is a right side view of the gear member of FIG. 7a.

FIG. 7d is an end view of the gear member of FIG. 7a.

FIG. 7e is a left side view of the gear member of FIG. 7a.

FIG. 8a is a perspective view of a hub of the dental flosser shown in FIG. 1.

FIG. 8b is an alternate perspective view of the hub of FIG. 8a.

FIG. 8c is a left side view of the hub of FIG. 8a.

FIG. 8d is an end view of the hub of FIG. 8a.

FIG. 8e is a right side view of the hub of FIG. 8a.

FIG. 9a is a perspective view of a pawl member of the dental flosser shown in FIG. 1.

FIG. 9b is an alternate perspective view of the pawl member of FIG. 9a.

FIG. 9c is a rear view of the pawl member of FIG. 9a.

FIG. 9d is a right side view of the pawl member of FIG. 9a.

FIG. 9e is a front view of the pawl member of FIG. 9a.

FIG. 10a is a perspective view of an actuator of the dental flosser shown in FIG. 1.

FIG. 10b is an alternate perspective view of the actuator of FIG. 10a.

FIG. 10c is a right side view of the actuator of FIG. 10a.

FIG. 10d is an end view of the actuator of FIG. 10a.

FIG. 10e is a left side view of the actuator of FIG. 10a.

FIG. 11a is a perspective view of a biasing member of the dental flosser shown in FIG. 1.

FIG. 11b is a top view of the biasing member of FIG. 11a.

FIG. 11c is a right side view of the biasing member of FIG. 11a.

FIG. 11d is a front view of the biasing member of FIG. 11a.

FIG. 12a is a perspective view of a wind-up spool of the dental flosser shown in FIG. 1.

FIG. 12b is an alternate perspective view of the wind-up spool of FIG. 12a.

FIG. 12c is a left side view of the wind-up spool of FIG. 12a.

FIG. 12d is a top view of the wind-up spool of FIG. 12a.

FIG. 12e is a right side view of the wind-up spool of FIG. 12a.

FIG. 13a is a perspective view of an inner spool of the dental flosser shown in FIG. 1.

FIG. 13b is an alternate perspective view of the inner spool of FIG. 13a.

FIG. 13c is a left side view of the inner spool of FIG. 13a.

FIG. 13d is a top view of the inner spool of FIG. 13a.

FIG. 13e is a right side view of the inner spool of FIG. 13a.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

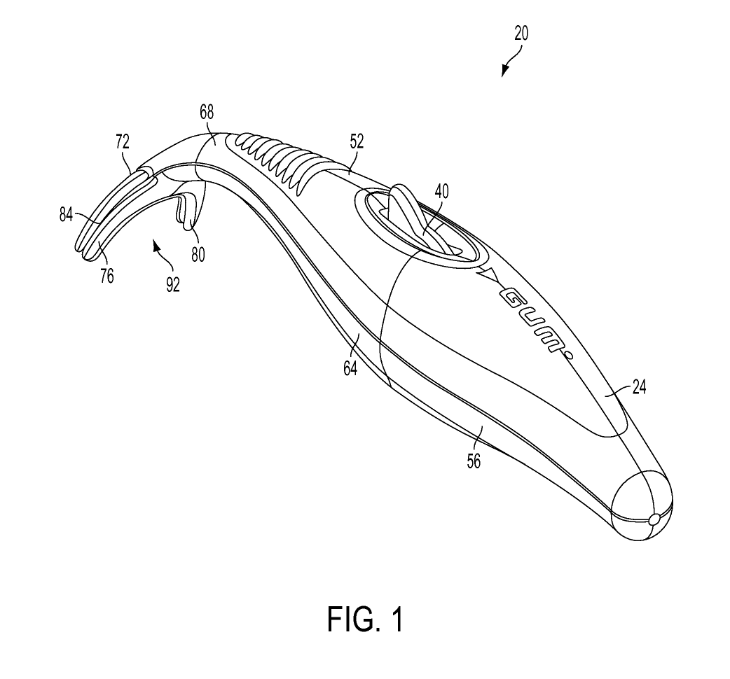

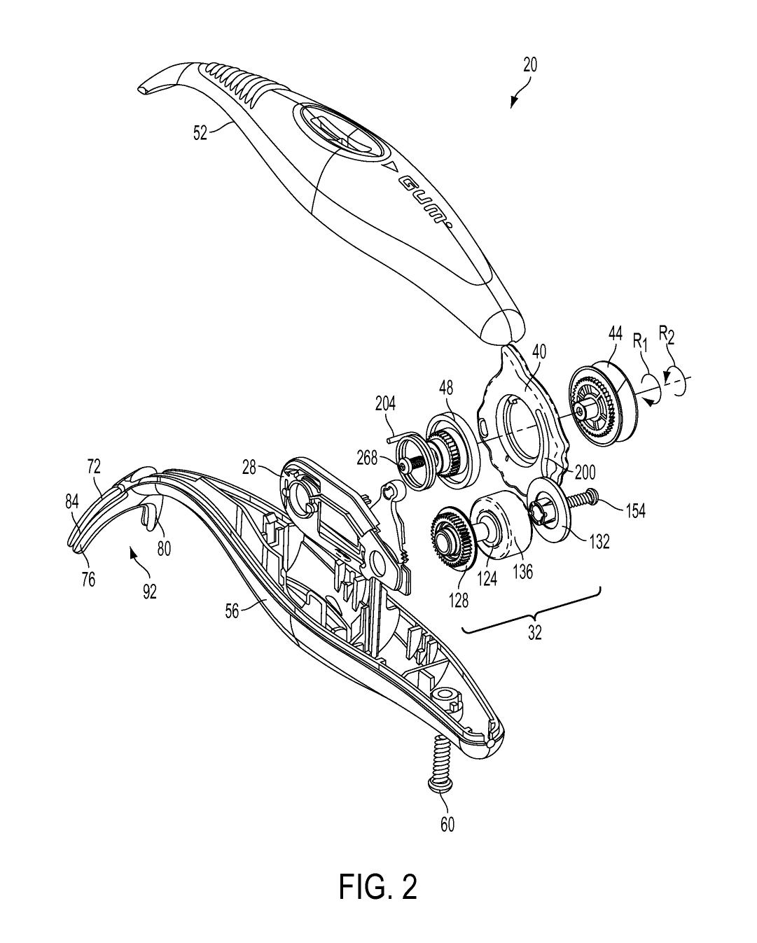

FIGS. 1 and 2 illustrate a dental flosser 20 embodying the invention. The dental flosser 20 is operable to hold a supply of dental floss for cleaning teeth. A portion of the dental floss is exposed and held in place by the flosser 20 to facilitate inserting the floss between a user's teeth. After the exposed portion of floss is used or otherwise becomes dirty, the dental flosser 20 is operable to advance a new, clean portion of floss for cleaning teeth.

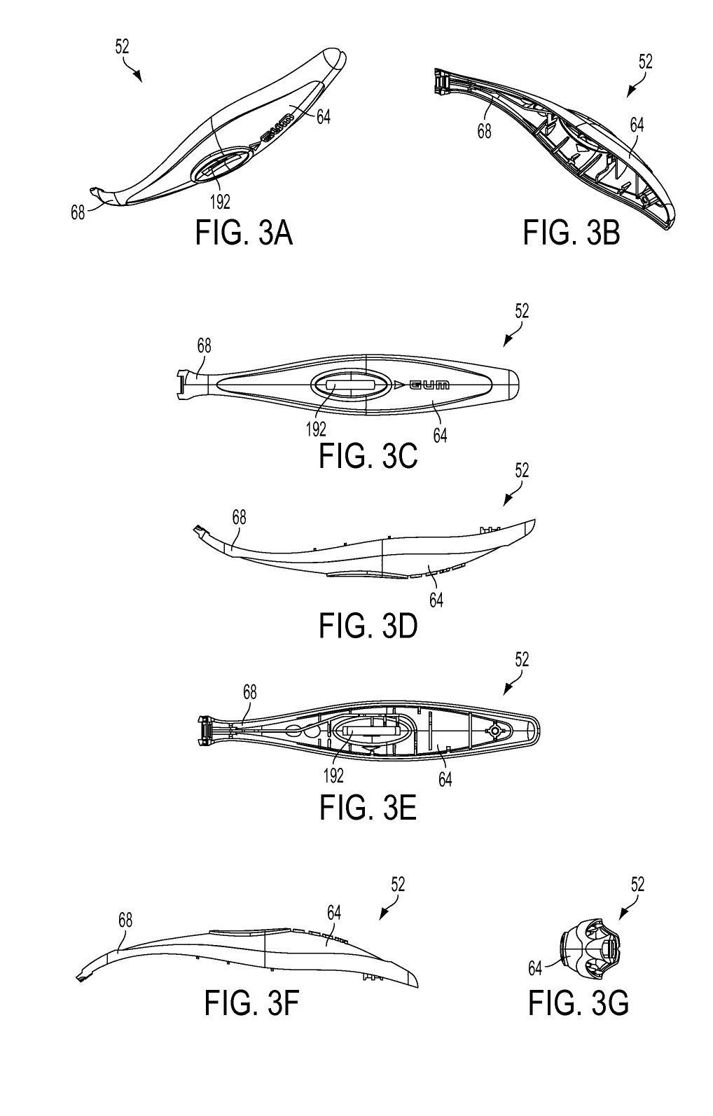

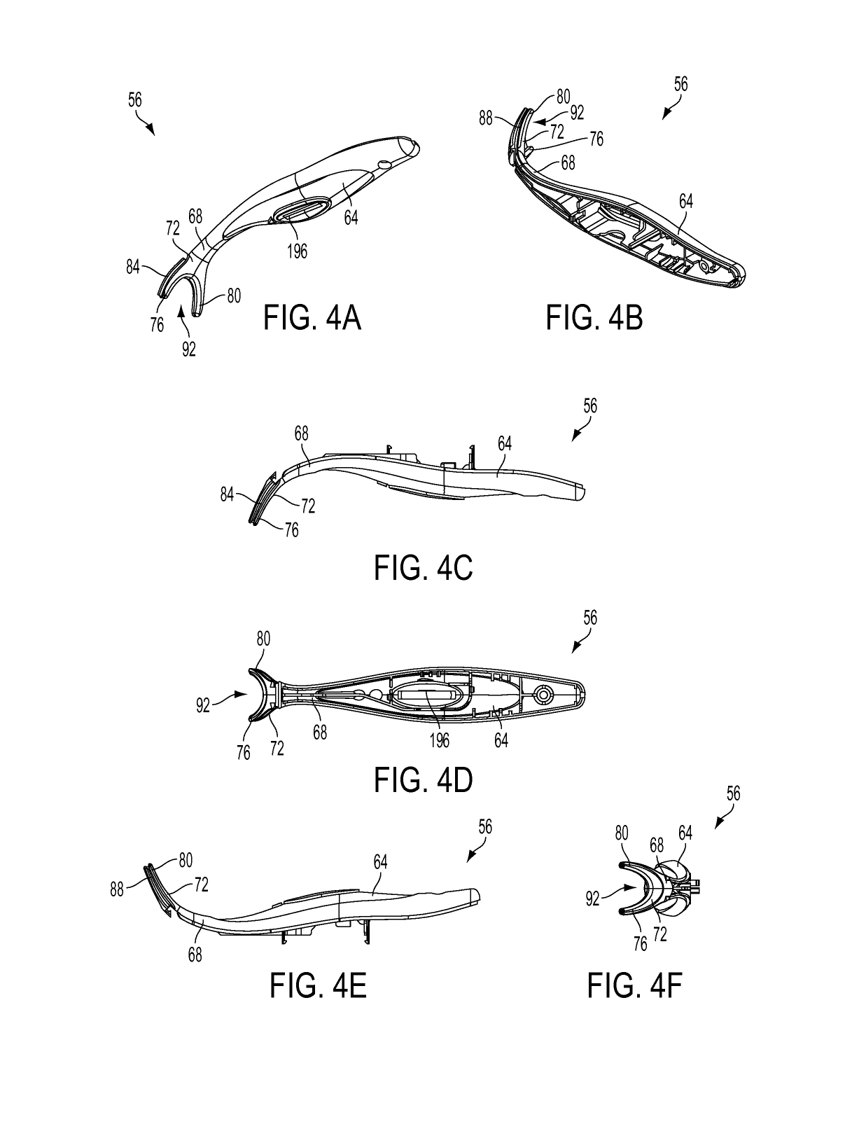

As shown in FIG. 2, the illustrated dental flosser 20 includes a body in the form of a housing assembly 24, a chassis 28, a supply core assembly 32, a pawl member 36, an actuator 40, a wind-up spool 44, and an inner spool 48. The housing assembly 24 includes a first, or upper, housing portion 52 (FIG. 3a) and a second, or lower, housing portion 56 (FIG. 4a). The upper and lower housing portions 52, 56 are secured together with a threaded fastener 60 to substantially enclose the internal components of the flosser 20. When assembled, the upper and lower housing portions 52, 56 define a grip or body 64 and a relatively narrow neck 68 extending from the body 64. In some embodiments, an elastomeric material may be molded over at least a portion of the housing assembly 24 to facilitate handling and gripping the flosser 20 during use.

Referring to FIGS. 4a-4f, the lower housing portion 56 includes a fork 72 coupled to and extending from the neck 68. The fork 72 includes two arms 76, 80, each of which defines a groove 84, 88. The illustrated arms 76, 80 are spaced apart to define a gap 92 therebetween and to support dental floss extending across the gap 92. The groove 84 in the first arm 76 receives dental floss from the supply core assembly 32 and guides the floss across the gap 92 to the second arm 80. The groove 88 in the second arm 80 receives the dental floss from the first arm 76 and guides the floss back into the housing assembly 24 toward the wind-up spool 44.

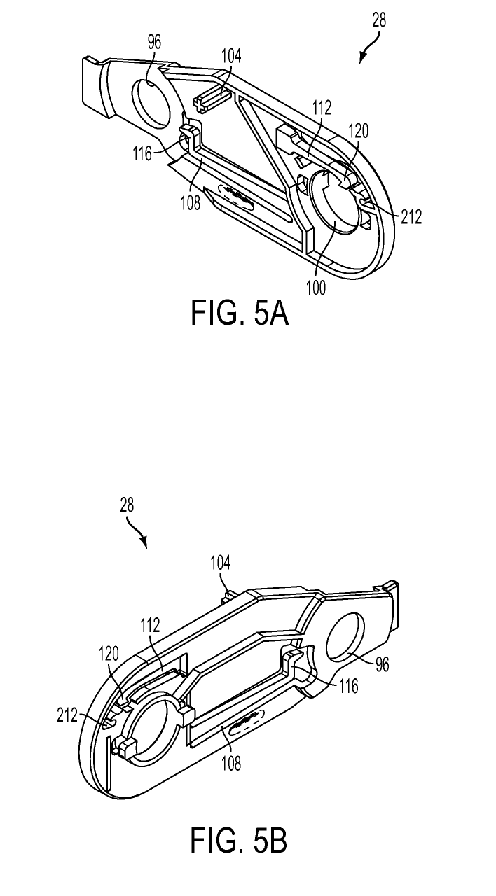

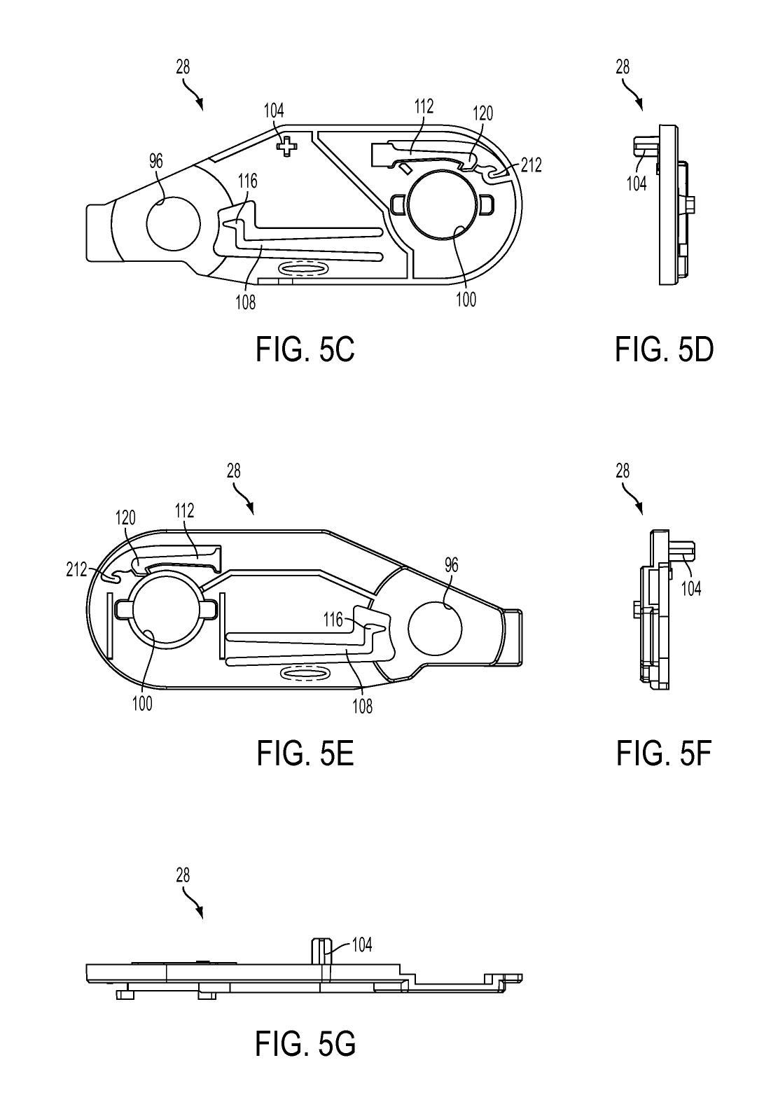

The chassis 28, or frame, is positioned substantially within the housing assembly 24 and supports the other internal components of the dental flosser 20. As shown in FIGS. 5a-5g, the chassis 28 defines two mounting apertures 96, 100 and includes a support post 104. The first mounting aperture 96 receives a portion of the supply core assembly 32 to rotatably couple the supply core assembly 32 to the chassis 28. The second mounting aperture 100 receives a portion of the inner spool 48 to rotatably couple the actuator 40, the wind-up spool 44, and the inner spool 48 to the chassis 28. The support post 104 supports the pawl member 36 for pivotal movement about the support post relative the chassis 28. The internal components of the dental flosser 20, including the supply core assembly 32, the inner spool 48 and wind-up spool 44, and the pawl member 36, can therefore be preassembled on the chassis 28 such that the chassis 28 and the other internal components are insertable into the housing assembly 24 as an insert or subassembly.

The chassis 28 also includes a first finger 108 including a tooth 116 that is positioned adjacent to the first mounting aperture 96, and a second finger 112 including a tooth 120 that is positioned adjacent to the second mounting aperture 100. Each finger 108, 112 is coupled to the chassis 28 at a fixed end and has the respective tooth 116, 120 formed at an opposite end. In the illustrated embodiment, the fingers 108, 112 are integrally formed as a single piece with the chassis 28. In other embodiments, the fingers 108, 112 may be separate components that are removably or permanently connected to the chassis 28. As further discussed below, the first tooth 116 engages the supply core assembly 32 and the second tooth 120 engages the inner spool 48 to limit movement (e.g., rotation) of the supply core assembly 32 and the inner spool 48 relative to the chassis 28.

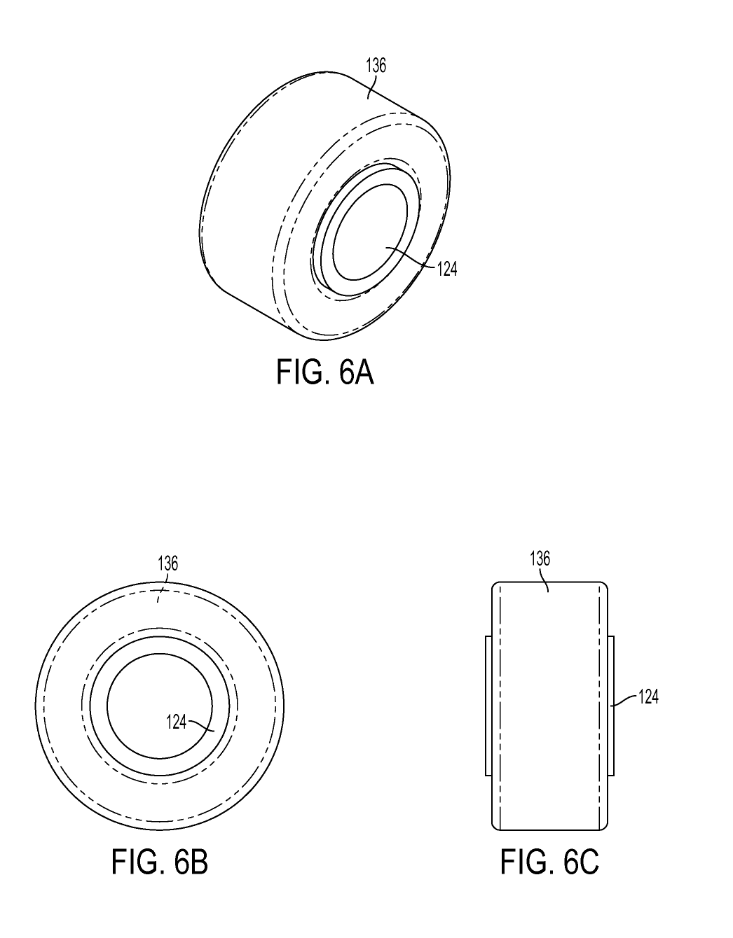

As shown in FIGS. 2, 6a-6c, 7a-7e, and 8a-8e, the supply core assembly 32 includes a core 124, a gear member 128, and a hub 132. The illustrated core 124 (FIGS. 6a-6c) is generally cylindrical and supports a supply of dental floss 136. The dental floss 136 is wound around the core 124 such that the floss 136 smoothly unwinds from the core 124 as the supply core assembly 32 rotates relative to the chassis 28. Pulling the dental floss 136 away from the supply core assembly 32 (e.g., by rotating the wind-up spool 44, as further discussed below) advances the floss 136 through the housing assembly 24 such that a fresh portion of dental floss extends across the fork 72.

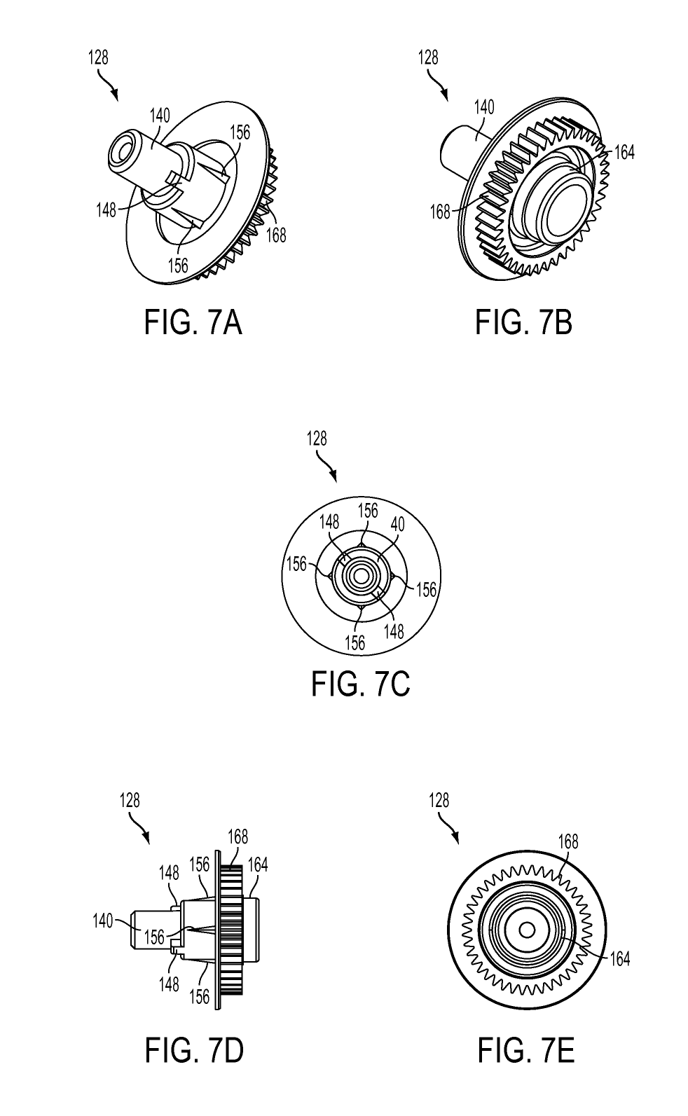

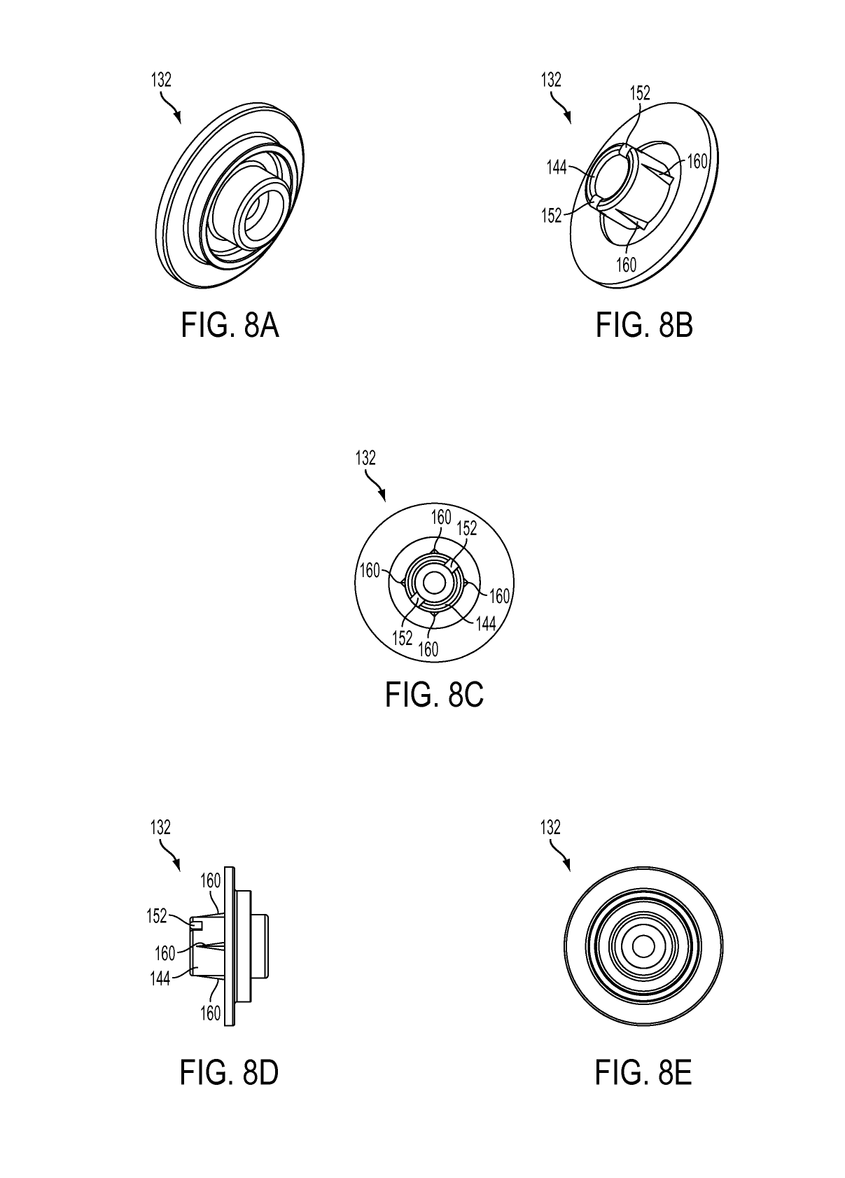

The gear member 128 and the hub 132 are positioned on substantially opposite sides of the core 124 to guide and support the core 124 during rotation (see FIG. 2). The gear member 128 (FIGS. 7a-7e) includes a post 140 that extends axially through the core 124 and is received in a boss 144 on the hub 132 (FIGS. 8a-8e). Two projections 148 are formed on the gear member 128 adjacent to the post 140. The projections 148 engage corresponding recesses 152 formed in the boss 144 of the hub 132 to prevent relative rotation between the gear member 128 and the hub 132. A threaded fastener 154 (FIG. 2) also extends through the post 140 and the boss 144 to threadably secure the gear member 128, the core 124, and the hub 132 together. Other configurations of the gear member 128 and hub 132 may include snap-fit or press-fit configurations for securing the gear member 128, the core 124, and the hub 132 together.

As shown in FIGS. 7a and 8b, the gear member 128 and the hub 132 include crush ribs 156, 160 adjacent to the post 140 and the boss 144, respectively. When the post 140 and the boss 144 are inserted into the core 124, the ribs 156, 160 deform the core 124 by forming grooves that engage the ribs 156, 160 to prevent movement of the core 124 relative to the gear member 128 or the hub 132. In some embodiments, other suitable coupling means, such as adhesives, may also or alternatively be employed to secure the core 124 to the gear member 128 and the hub 132.

The gear member 128 also includes a cylindrical bearing surface 164 and a plurality of teeth 168. The bearing surface 164 and the teeth 168 are formed on a side of the gear member 128 that is opposite the post 140. The bearing surface 164 fits within the first mounting aperture 96 (FIG. 5a) of the chassis 28 to couple the supply core assembly 32 to the chassis 28, while still allowing rotation of the supply core assembly 32 relative to the chassis 28. The teeth 168 are engaged by the first tooth 116 (FIG. 5a) of the chassis 28 to inhibit free rotation of the supply core assembly 32 relative to the chassis 28. When the supply core assembly rotates 32, the finger 108 deflects as the first tooth 116 rides up and over an individual one of the teeth 168, at which point the first tooth 116 snaps back into the space between the next pair of teeth 168. The engagement between the teeth 168 and the first tooth 116 prevents free-wheeling rotation of the supply core assembly 32 relative to the chassis 28 and provides an audible and tactile output to a user when the supply core assembly 32 rotates.

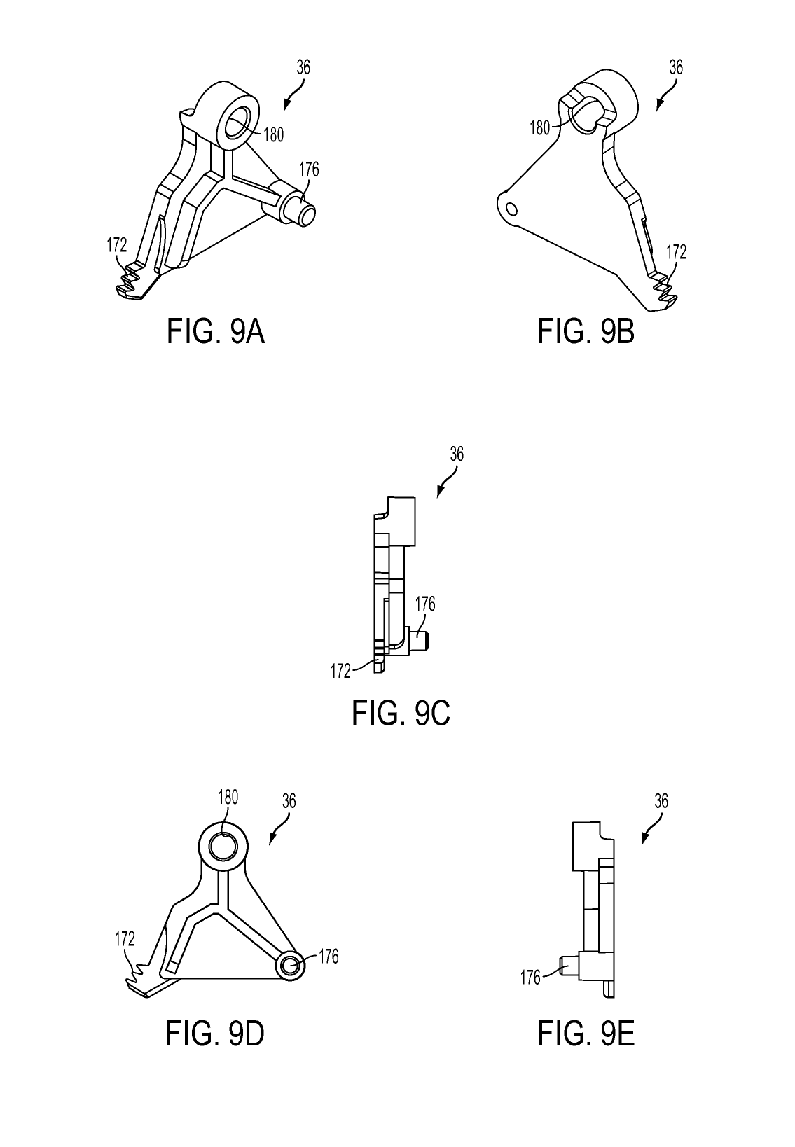

The pawl member 36 selectively engages a portion of the teeth 168 to prevent rotation of the supply core assembly 32 relative to the chassis 28. As shown in FIGS. 9a-9e, the pawl member 36 is generally triangle-shaped and includes at its corners a toothed portion 172, a pin 176, and an opening 180. The support post 104 of the chassis 28 extends through the opening 180 in the pawl member 36 to pivotally couple the pawl member 36 to the chassis 28. In the illustrated embodiment, the pawl member 36 is pivotable relative to the chassis 28 between an engaged position, in which the toothed portion 172 engages the teeth 168 of the gear member 128 (see FIG. 7b) to prevent rotation of the supply core assembly 32, and a disengaged position in which the toothed portion 172 is spaced apart from the gear member 128 and does not engage the teeth 168 to allow rotation of the supply core assembly 32. The pin 176 extends outwardly from the pawl member 36 for engagement with the actuator 40 such that the actuator 40 is operable to move the pawl member 36 between the engaged and disengaged positions, as discussed further below.

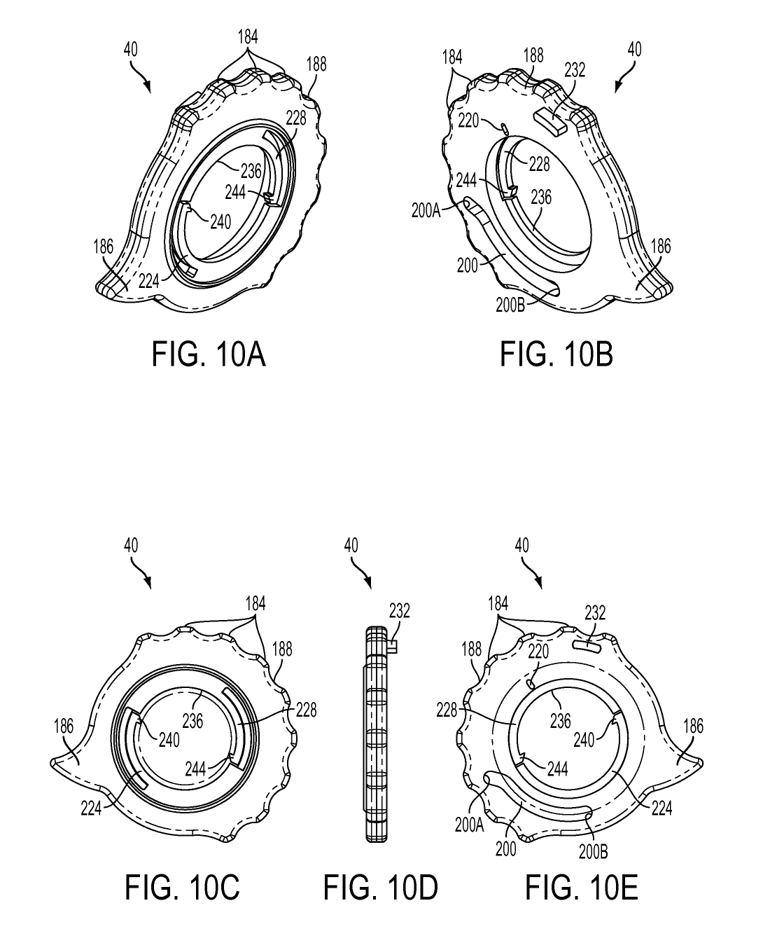

As shown in FIGS. 10a-10e, the illustrated actuator 40 is a thumbwheel that includes a plurality of ridges 184 and an actuator tab 186 formed on an outer perimeter 188. In some embodiments, the actuator may include ridges 184 extending around the entire outer perimeter 188 in lieu of the combination of ridges 184 and the actuator tab 186 shown in FIGS. 10a-10e. In other embodiments, at least a portion of the actuator 40 may be over-molded with an elastomeric material to facilitate gripping the actuator 40. In still other embodiments, other suitable manipulation features such as slides, levers, and the like, may be employed. The actuator 40 is rotatably coupled to the chassis 28 by the wind-up spool 44 and the inner spool 48 and extends through slot openings 192, 196 (FIGS. 3e and 4d) in the upper and lower housing portions 52, 56.

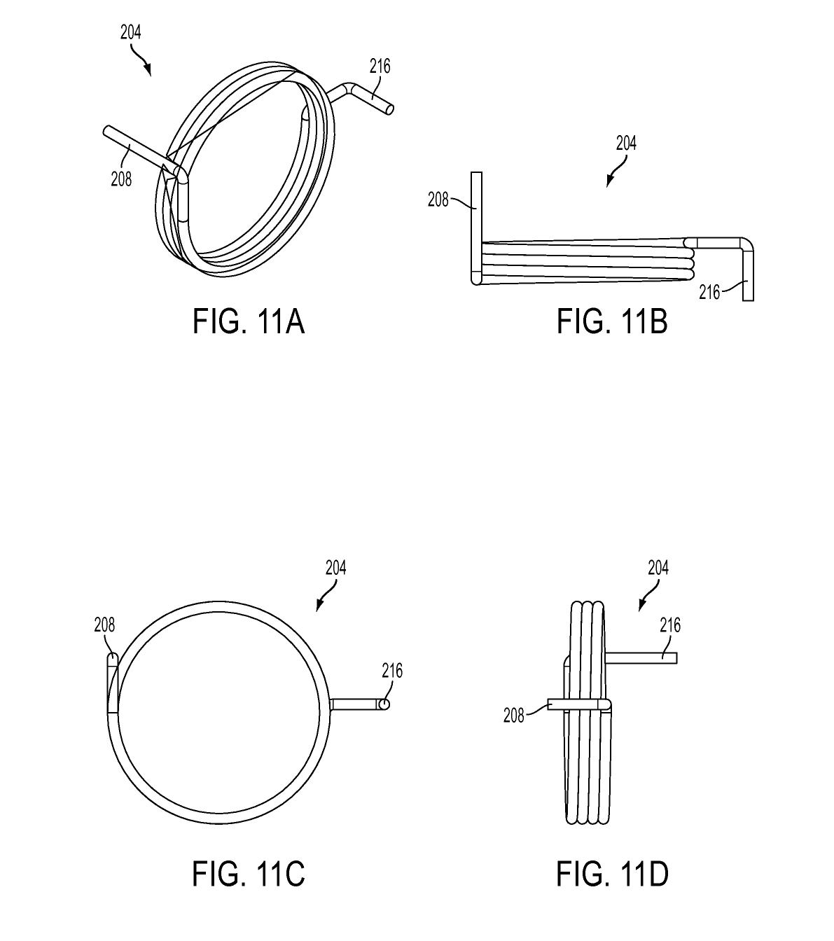

An elongated cam slot 200 is formed in a face of the actuator 40 for receiving the pin 176 of the pawl member 36 (FIGS. 2, 10b, 10e). When the actuator 40 is rotated by a user in a first direction R₁ (FIG. 2), the pin 176 moves from a radially-outermost portion 200A of the slot 200 to a radially-innermost portion 200B of the slot 200, thereby pivoting the pawl member 36 about the support post 104 and disengaging the pawl member 36 from the gear member 128 to allow rotation of the supply core assembly 32. When the actuator 40 is released, the actuator 40 is rotated in a second direction R₂ (FIG. 2) by a biasing member 204 (FIGS. 2 and 11a-11d). As the actuator 40 rotates in the second direction R₂, the pin 176 moves from the radially-innermost portion 200B of the slot 200 back to the radially-outermost portion 200A of the slot 200, thereby returning the pawl member 36 into engagement with the gear member 128 (i.e., the engaged position) to prevent rotation of the supply core assembly 32.

As shown in FIG. 2, the biasing member 204 is positioned within the housing assembly 24 and is coupled to the chassis 28 and the actuator 40. The illustrated biasing member 204 is a torsion spring, although other suitable biasing members may be employed. As shown in FIGS. 11a-11d, the biasing member 204 includes a first leg 208 that extends into an opening 212 (FIGS. 5a-5c and 5e) in the chassis 28 and a second leg 216 that extends into an opening 220 (FIGS. 10b and 10e) in the actuator 40. When the actuator 40 is rotated in the first direction R₁, the legs 208, 216 of the biasing member 204 are radially deflected relative to one another, thereby storing energy in the biasing member 204. Releasing the actuator 40 releases the energy stored in the biasing member 204 such that the biasing member 204 rotates the actuator in the second direction R₂ and returns the actuator 40 to its original position.

Referring again to FIGS. 10a-10e, the actuator 40 includes two arcuate and resilient fingers 224, 228 extending circumferentially around an inner perimeter 236 of the actuator 40, and a stop member 232 extending axially from the left side face of the actuator 40. Each arcuate finger 224, 228 is coupled to the inner perimeter 236 of the actuator 40 at one end and defines a tooth 240, 244 at the opposite end. In the illustrated embodiment, the fingers 224, 228 are integrally formed as a single piece with the actuator 40. In other embodiments, the fingers 224, 228 may be separate components that are removably or permanently connected to the actuator 40. The teeth 240, 244 engage the wind-up spool 44 to rotate the wind-up spool 44 with the actuator 40 in the first direction R₁, as further discussed below. The stop member 232 is formed on the same face of the actuator 40 as the elongated slot 200 and extends toward the chassis 28. The stop member 232 engages a corresponding protrusion on the chassis 28 to prevent over-rotation of the actuator 40 relative to the chassis 28.

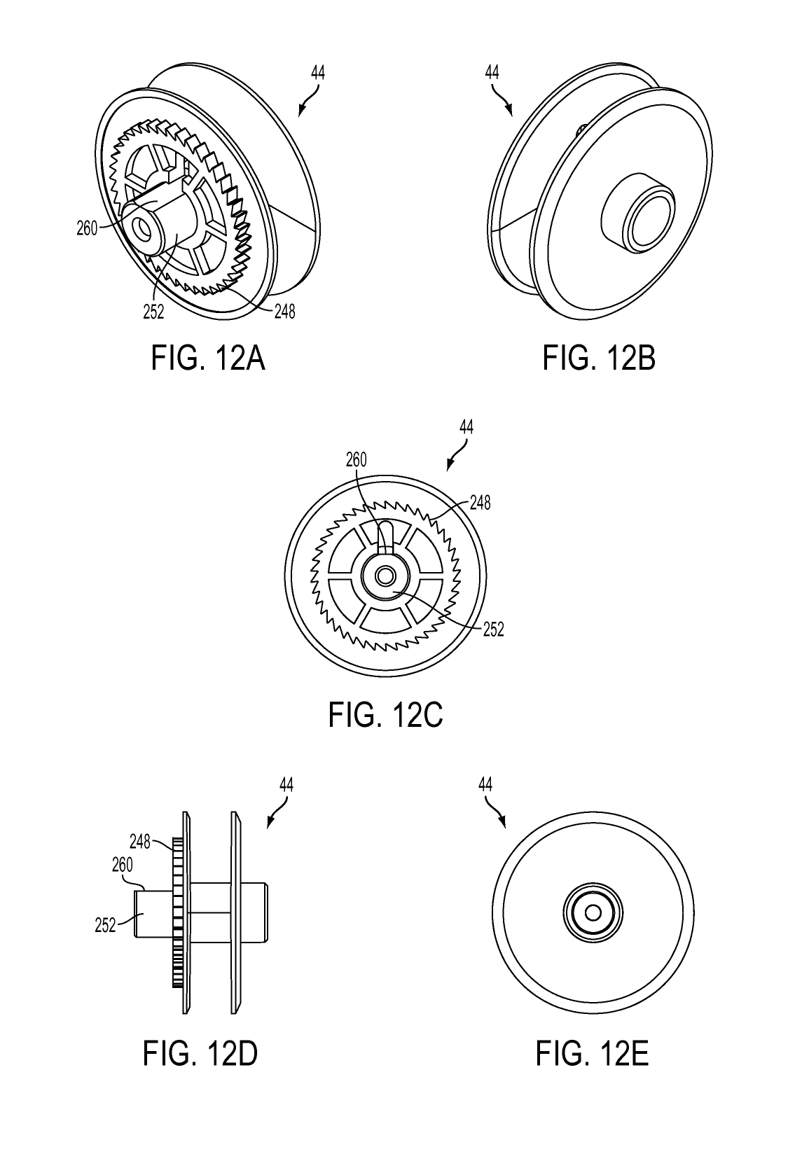

The wind-up spool 44 rotates with the actuator 40 in the first direction R₁ to pull dental floss from the supply core assembly 32. As shown in FIGS. 12a, 12c, and 12d, the wind-up spool 44 includes a plurality of teeth 248. The teeth 248 are positioned adjacent to the inner perimeter 236 of the actuator 40 and engage the teeth 240, 244 of the actuator 40 when the wind-up spool 44 and actuator are assembled. In the illustrated embodiment, the teeth 248 of the wind-up spool 44 are tilted or angled such that the wind-up spool 44 is only rotatable in one direction in a ratchet-like manner. That is, when the actuator 40 is rotated in the first direction R₁, the teeth 240, 244 of the actuator 40 engage the teeth 248 of the wind-up spool 44 to rotate the wind-up spool 44 in the first direction R₁. However, when the actuator 40 rotates in the second direction R₂, the wind-up spool 44 is held fixed by the inner spool 48 (as discussed below) and the teeth 240, 244 of the actuator 40 ride over the teeth 248 of the wind-up spool 44 such that the actuator 40 rotates relative to the wind-up spool 44.

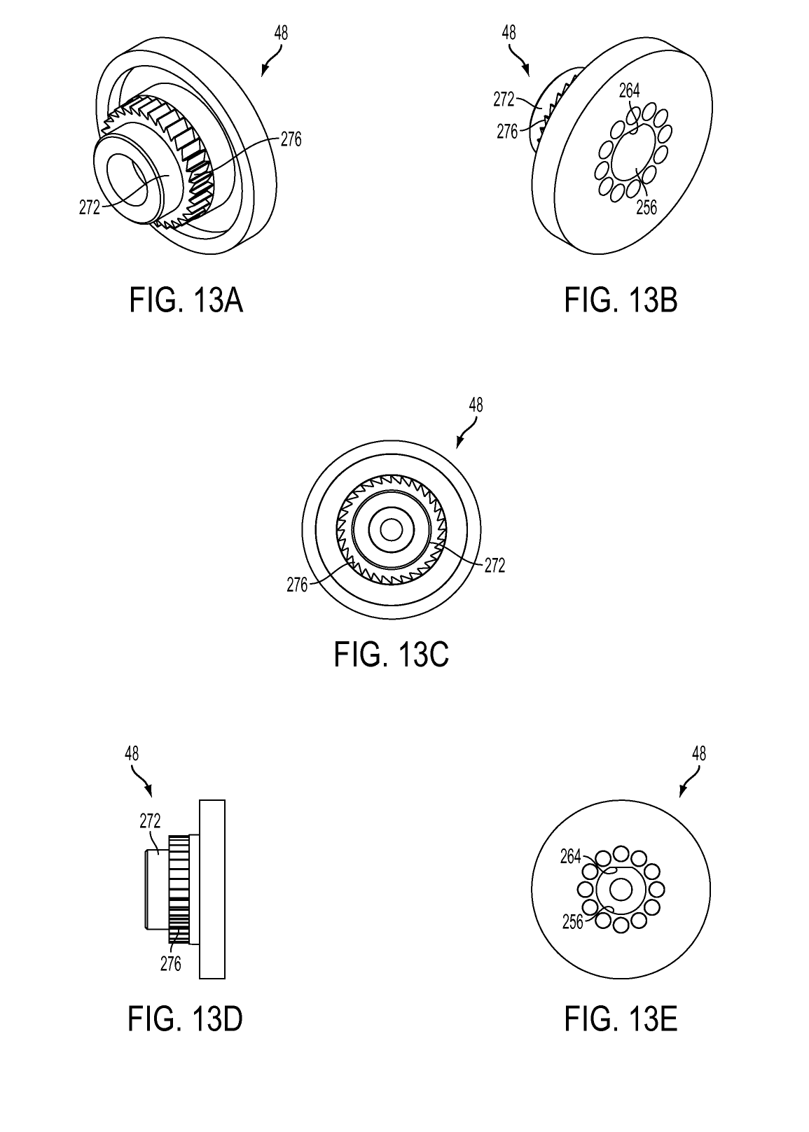

Referring to FIGS. 12a-13e, the illustrated wind-up spool 44 also includes a post 252 that extends axially through the actuator 40 and is received in an opening 256 of the inner spool 48. In the illustrated embodiment, the post 252 includes a flattened surface 260 that engages a flattened inner surface 264 of the inner spool 48 to prevent relative rotation between the wind-up spool 44 and the inner spool 48. In other embodiments, other suitable coupling means (e.g., splines, press-fitting, adhesives, etc.) may be employed to prevent relative rotation between the wind-up spool 44 and the inner spool 48. A threaded fastener 268 (FIG. 2) extends through the post 252 and the opening 256 to secure the spools 44, 48 and the actuator 40 together. Although the inner spool 48 and the wind up spool 44 are illustrated as two components, they could also be formed as a single piece. In this regard, the inner spool 48 and the features thereof may be construed as being or forming a portion of the wind up spool 44.

As shown in FIGS. 13a-13e, the inner spool 48 includes a cylindrical bearing surface 272 and a plurality of teeth 276. The bearing surface 272 and the teeth 276 are formed on a side of the inner spool 48 that faces the chassis and is opposite the opening 256. The bearing surface 272 fits within the second mounting aperture 100 (FIGS. 5a, 5c, 5e) of the chassis 28 to couple the inner spool 48 to the chassis 28 while allowing rotation of the inner spool 48 and the wind-up spool 44 relative to the chassis 28.

The teeth 276 of the inner spool 48 are tilted or angled such that, similar to the wind-up spool 44, the inner spool 48 is only rotatable relative to the chassis 28 in one direction (e.g., the direction R₁) in a ratchet-like manner. When the wind-up spool 44 and inner spool 48 are rotated by the actuator 40 in the first direction R₁, the second tooth 120 (FIG. 5) of the chassis 28 rides over the teeth 276 of the inner spool 48, thereby allowing the inner spool 48, the wind-up spool 44, and the actuator 40 to rotate relative to the chassis 28 in the first direction R₁. However, as the actuator 40 is rotated in the direction R₂ under the influence of the biasing member 204, the second tooth 120 (FIG. 5c) of the chassis 28 engages the teeth 276 of the inner spool 48 and prevents rotation of the inner spool 48 and the wind-up spool 44 in the second direction R₂. The actuator 40, on the other hand, rotates relative to the inner spool 48 and the wind-up spool 44 as the teeth 240, 244 of the actuator 40 ride over the teeth 248 of the wind-up spool 44.

Referring back to FIG. 2, the dental flosser 20 is assembled by first coupling the internal components of the flosser 20 to the chassis 28. The pawl member 36 is coupled to the chassis 28 at the support post 104 (FIG. 5a). The core 124, the gear member 128, and the hub 132 of the supply core assembly 32 are coupled together with the threaded fastener 154. The bearing surface 164 of the gear member 128 is then inserted into the first mounting aperture 96 in the chassis 28 such that the teeth 168 of the gear member 128 engage or intermesh with the toothed portion 172 of the pawl member 36. Similarly, the actuator 40, the wind-up spool 44, and the inner spool 48 are coupled together with the threaded fastener 268. The bearing surface 272 of the inner spool 48 is then inserted into the second mounting aperture 100 in the chassis 28. As the inner spool 48 is coupled to the chassis 28, the first leg 208 of the biasing member 204 is inserted into the opening 212 in the chassis 28 and the second leg 216 of the biasing member 204 is inserted into the opening 220 in the actuator 40. In addition, the pin 176 of the pawl member 36 is inserted into the elongated cam slot 200 in the actuator 40 to couple the pawl member 36 to the actuator 40.

Once the internal components of the dental flosser 20 are coupled to the chassis 28, the chassis 28 and the other internal components are inserted into the lower housing portion 56 as a single subassembly. A portion of dental floss is then unwound from the supply core assembly 32 and threaded through the lower housing portion 56 to the fork 72. The dental floss is pulled across the gap 92 in the fork 72, threaded back through the lower housing portion 56, and coupled to the wind-up spool 44. The dental floss is thereby held in place between the supply core assembly 32 and the wind-up spool 44. After the dental floss is properly positioned within the lower housing portion 56 and coupled to the wind-up spool 44, the upper housing portion 52 is aligned with the lower housing portion 56 to substantially enclose the internal components of the dental flosser 20. The upper and lower housing portions 52, 56 are then secured together with the threaded fastener 60.

In operation, a portion of the dental floss extending across the arms 76, 80 of the fork 72 is insertable between a user's teeth to clean the teeth. After the portion of dental floss is used or otherwise becomes dirty, a new or fresh portion of dental floss may be advanced from the supply core assembly 32 across the fork 72. To advance the dental floss through the housing assembly 24, the actuator 40 is rotated in the first direction R₁. As the actuator 40 rotates, the teeth 240, 244 of the actuator 40 engage the teeth 248 of the wind-up spool 44 to rotate the wind-up spool 44 and the inner spool 48 with the actuator 40 in the direction R₁. In addition, the pin 176 of the pawl member 36 moves from the radially-outermost portion 200A of the slot 200 in the actuator 40 to the radially-innermost portion 200B of the slot 200 such that the pawl member 36 is pivoted away from the gear member 128 to the disengaged position. When the pawl member 36 is in the disengaged position, the supply core assembly 32 is rotatable relative to the chassis 28 to release the dental floss.

Rotating the wind-up spool 44 in the first direction R₁ pulls the dental floss from the supply core assembly 32 and winds the floss onto the wind-up spool 44. Pulling the dental floss rotates the supply core assembly 32 relative to the chassis 28 such that the floss is advanced through the housing assembly 24 and across the fork 72. As the supply core assembly 32 rotates, the first tooth 116 of the chassis 28 moves between the teeth 168 of the gear member 128, creating an audible and tactile output (e.g., a clicking sound and a detent feel) to notify the user that the dental floss is being advanced through the flosser 20.

When the actuator 40 is released, the biasing member 204 biases the actuator 40 to rotate in the second direction R₂. As discussed above, the wind-up spool 44 and inner spool 48 are prevented from rotating in the second direction R₂ due to engagement between the second tooth 120 (FIGS. 5a and 5c) of the chassis 28 and the teeth 276 of the inner spool 48, but the actuator 40 is allowed to rotate relative to the wind-up spool 44 and the inner spool 48 in the second direction R₂ because the teeth 240, 244 of the actuator 40 are configured to ride over the teeth 248 of the wind-up spool 44. This arrangement prevents the dental floss from unwinding from the wind-up spool 44 when the actuator 40 rotates in the second direction R₂. As the actuator 40 rotates in the second direction R₂, the pin 176 of the pawl member 36 also moves from the radially-innermost portion 200B of the slot 200 in the actuator 40 to the radially-outermost portion 200A of the slot 200 such that the pawl member 36 is pivoted toward the gear member 128 to the engaged position. When in the engaged position, the toothed portion 172 of the pawl member 36 engages the teeth 168 of the gear member 128 to prevent further rotation of the supply core assembly 32 relative to the chassis 28. In this way, both the supply core assembly 32 and the wind-up spool 44 are prevented from rotating, thereby preventing the unwinding of additional floss such that the floss extending across the fork 72 may be used to clean teeth.

In some constructions, once the supply core assembly 32 has been completely unwound and no fresh floss is present, the upper housing 52 may be removed from the lower housing 56 and the subassembly may be replaced to provide a new spool of fresh floss.

Although the invention has been described in detail with reference to certain preferred embodiments, variations and modifications exist within the scope and spirit of one or more independent aspects of the invention as described.

1. A dental flosser comprising:
a body including a pair of arms spaced apart to define a gap therebetween;
a supply core rotatably coupled to the body;
a wind-up spool rotatably coupled to the body;
a pawl movable between an engaged position that restricts rotation of the supply core, and a disengaged position that allows the supply core to rotate; and
an actuator operable to move the pawl from the engaged position to the disengaged position and to rotate the wind-up spool.

2. The dental flosser of claim 1, wherein rotating the wind-up spool in the first direction winds a length of floss onto the wind-up spool.

3. The dental flosser of claim 1, wherein the wind-up spool includes a first set of teeth engaging the actuator and a second set of teeth engaging the body.

4. The dental flosser of claim 1, further comprising a chassis removably coupled to the body, wherein the supply core, the wind-up spool, the actuator, and the pawl are coupled to the chassis and are removable from and insertable into the body as a replaceable unit.

5. The dental flosser of claim 1, wherein the pawl includes a pin and the actuator includes a cam slot for receiving the pin, the actuator rotatable between a first position wherein the pin is positioned in a first portion of the cam slot and the pawl is in the engaged position, and a second position wherein the pin is positioned in a second portion of the cam slot and the pawl is in the disengaged position.

6. The dental flosser of claim 5, further comprising a biasing member operatively coupled to the actuator and biasing the actuator towards the first position.

7. The dental flosser of claim 1, wherein the pawl includes an engagement portion engagable with the supply core, the engagement portion engaging the supply core when the pawl is in the engaged position to prevent rotation of the supply core, and the engagement portion being disengaged from the supply core when the pawl is in the disengaged position to allow rotation of the supply core.

8. The dental flosser of claim 1, wherein the supply core, wind-up spool, and pawl are positioned within the body, the body defining an opening, and wherein a portion of the actuator extends through the opening.

9. The dental flosser of claim 1, further comprising a length of floss having a first portion wound about the wind-up spool, a second portion wound about the supply core, and a third portion extending between the supply core and the wind-up spool and spanning the gap, and wherein operation of the actuator advances the length of floss from the supply core, along the gap, and to the wind-up spool.

10. A dental flosser comprising:
a body including a pair of arms spaced apart to define a gap therebetween;
a wind-up spool rotatably coupled to the body for rotation only in a first direction with respect to the body;
a supply core rotatably coupled to the body;
a pawl engagable with the supply core to limit rotation of the supply core with respect to the body;
a length of floss having a first portion wound about the wind-up spool assembly, a second portion wound about the supply core, and a third portion extending between the supply core and the wind-up spool and spanning the gap; and
an actuator operatively coupled to the pawl and the take-up spool, the actuator operable to move the pawl from an engaged position to a disengaged position and to rotate the wind-up spool in the single direction, thereby advancing the length of floss through the dental flosser.

11. The dental flosser of claim 10, wherein the actuator is rotatably coupled to the wind-up spool for rotation only in a second direction with respect to the wind-up spool.

12. The dental flosser of claim 10, wherein the wind-up spool includes a first set of ratchet teeth engaging the actuator and a second set of ratchet teeth engaging the body.

13. The dental flosser of claim 10, further comprising a chassis removably coupled to the body, wherein the supply core, the wind-up spool, the actuator, and the pawl are coupled to the chassis and are removable from and insertable into the body as a replaceable unit.

14. The dental flosser of claim 10, wherein the pawl includes a pin and the actuator includes a cam slot for receiving the pin, the actuator rotatable between a first position wherein the pin is positioned in a first portion of the cam slot and the pawl is in the engaged position, and a second position wherein the pin is positioned in a second portion of the cam slot and the pawl is in the disengaged position.

15. The dental flosser of claim 14, further comprising a biasing member operatively coupled to the actuator and biasing the actuator towards the first position.

16. The dental flosser of claim 10, wherein the pawl includes an engagement portion engagable with the supply core, the engagement portion engaging the supply core when the pawl is in the engaged position to prevent rotation of the supply core, and the engagement portion being disengaged from the supply core when the pawl is in the disengaged position to allow rotation of the supply core.

17. The dental flosser of claim 10, wherein the supply core, wind-up spool, pawl, and actuator are positioned within the body, the body defining an opening, and wherein a portion of the actuator extends through the opening.

18. A dental flosser comprising:
a body including a pair of arms spaced apart to define a gap therebetween;
an insert positionable within the body, the insert including,
a chassis having a first mounting aperture, a second mounting aperture, and a mounting pin,
a wind-up spool rotatably coupled to the first mounting aperture and limited to rotation in a single direction with respect to the chassis,
a supply core rotatably coupled to the second mounting aperture of the chassis,
a pawl pivotally coupled to the mounting pin, the pawl pivotable between an engaged position that restricts rotation of the supply core with respect to the chassis, and a disengaged position that allows the supply core to rotate with respect to the chassis, and
an actuator rotatably coupled to the wind-up spool and operatively coupled to the pawl; and
a length of floss having a first portion wound about the wind-up spool, a second portion wound about the supply core, and a third portion extending between the supply core and the wind-up spool and spanning the gap.

19. The dental flosser of claim 18, wherein the actuator is rotatably coupled to the wind-up spool for rotation relative to the wind-up spool in only one direction.

20. The dental flosser of claim 18, wherein the wind-up spool includes a first set of ratchet teeth engaging the actuator and a second set of ratchet teeth engaging the body.

21. The dental flosser of claim 18, wherein the pawl includes a pin and the actuator includes a cam slot for receiving the pin, the actuator rotatable between a first position wherein the pin is positioned in a first portion of the cam slot and the pawl is in the engaged position, and a second position wherein the pin is positioned in a second portion of the cam slot and the pawl is in the disengaged position.

22. The dental flosser of claim 21, further comprising a biasing member operatively coupled to the actuator and biasing the actuator towards the first position.

23. The dental flosser of claim 18, wherein the pawl includes an engagement portion engagable with the supply core, the engagement portion engaging the supply core when the pawl is in the engaged position to prevent rotation of the supply core, and the engagement portion being disengaged from the supply core when the pawl is in the disengaged position to allow rotation of the supply core.

24. The dental flosser of claim 18, wherein the supply core, wind-up spool, pawl, and actuator are positioned within the body, the body defining an opening, and wherein a portion of the actuator extends through the opening.
